(19) United States
(12) Patent Application Publication
(10) Pub. No.: US 2021/0253761 A1
(43) Pub. Date: Aug. 19, 2021

(54) FLEXIBLE VDF POLYMERS

(71) Applicant: SOLVAY SPECIALTY POLYMERS ITALY S.P.A., Bollate (IT)

(72) Inventors: Ségolène BRUSSEAU, Tavaux (FR); Julio A. ABUSLEME, Saronno (IT)

(21) Appl. No.: 17/055,242

(22) PCT Filed: May 16, 2019
(86) PCT No.: PCT/EP2019/062552

§ 371 Date: Nov. 13, 2020

(30) Foreign Application Priority Data
May 17, 2018 (EP) 18305616.7

(51) Int. Cl. C08F 214/22; C08J 5/18

(52) U.S. Cl. CPC C08F 214/225; C08J 2327/16; C08J 5/18

(57) ABSTRACT

The present invention pertains to vinylidene fluoride copolymers comprising recurring units derived from hydrophilic (meth)acrylic monomers and from perfluoroalkylvinylether monomers having improved flexibility, to films made thereof and to processes for the manufacture of these films.

### CROSS-REFERENCE TO RELATED APPLICATIONS

This application claims priority to European application No. 18305616.7 filed on 17 May 2018, the whole content of those applications being incorporated herein by reference for all purposes.

### TECHNICAL FIELD

The present invention pertains to vinylidene fluoride copolymers comprising recurring units derived from hydrophilic (meth)acrylic monomers and from perfluoroalkylvinylether monomers having improved flexibility, to a process for their manufacture, and to their use in applications where outstanding flexibility is required.

### BACKGROUND ART

Fluoropolymers are known in the art to be excellent materials used in a variety of applications and environments due to their intrinsic chemical resistance and good mechanical properties.

Thermoplastic fluoropolymers can be extruded or solution casted to form films that can be used for example in lithium ion batteries as binder for the electrodes and for the separator.

Examples of such fluorinated polymeric materials are polyvinylidene fluoride homopolymers (PVDF) and vinylidene fluoride (VDF) copolymer resins, such as poly(vinylidene fluoride-chlorotrifluoroethylene) (VDF-CTFE), poly(vinylidene fluoride-tetrafluoroethylene) (VDF-TFE), poly(vinylidene fluoride-hexafluoropropylene) (VDF-HFP) and poly(vinylidene fluoride-trifluoroethylene) (VDF-TrFE).

VDF copolymers comprising recurring units derived from hydrophilic (meth)acrylic monomers (e.g. acrylic acid) are well known in the art.

EP2147029 (Solvay Specialty Polymers Italy SpA) 30 Oct. 2008, discloses VDF linear copolymers comprising recurring units derived from hydrophilic (meth)acrylic monomers randomly distributed throughout the whole VDF backbone, that is to say, in which the recurring units deriving from the hydrophilic (meth)acrylic monomers are each mainly comprised between two recurring units of VDF monomers; said copolymers exhibit improved thermal stability in comparison with copolymers having an uneven distribution of hydrophilic (meth)acrylic monomers and VDF monomers.

Such copolymers have been developed aiming at adding to the mechanical properties and chemical inertness of VDF homopolymers suitable adhesion towards metals, e.g. aluminium or copper, or hydrophilic properties.

In some recent applications, such as in flexible batteries, fluoropolymer in the form of thin films must be bended several times during the life-time in a given structure or device.

Fluoropolymers characterized by a very high flexibility while keeping the mechanical properties and the chemical resistance of the fluoropolymer itself are thus needed.

Fluorinated copolymers including recurring units derived from fluorinated olefinic monomers and recurring units derived from perfluoroalkyvinylether units are known in the art, the presence of said perfluoroalkylvinylether units being associated with the improvement of certain properties of the material, thermal stability in particular.

Melt-processable fluoropolymers derived from tetrafluoroethylene and perfluoroalkylvinylethers, which are commonly known in the art for being suitable for manufacturing shaped articles such as pipes, typically comprise from 1% to 5% by moles of recurring units derived from said perfluoroalkylvinylethers.

However, the reactivity of the perfluoroalkylvinylethers is very low and fluorinated copolymers including units derived from fluorinated olefinic monomers and recurring units derived from PAVE monomers are generally obtained with very long reaction times, which is a serious drawback from the industrial point of view.

U.S. Pat. No. 4,487,903 (Daikin Industries Ltd) 29 Sep. 1982, refers to the preparation of fluoroelastomeric copolymers using TFE and perfluoro vinylethers. The reactivity of the described vinyl ethers is very low and the polymer is obtained with very long reaction times (96 hours of polymerization is described in the experimental part).

One aim of the present invention is to provide a VDF-based polymer comprising recurring units derived from hydrophilic (meth)acrylic monomers and recurring units deriving from perfluoroalkylvinylether monomers that can be manufactured in the form of film having good flexible-life, chemical resistance and good adhesion to substrates, and is obtained by a polymerization process having improved productivity.

### SUMMARY OF INVENTION

The Applicant has now surprisingly found that when combining in a VDF-based polymer recurring units derived from both a hydrophilic (meth)acrylic monomer and a perfluorinated alkylvinylether in well-defined amounts, it is advantageously possible to significantly improve performances of the VDF-based polymer, in particular in terms of flexibility, while maintaining the good intrinsic mechanical and chemical properties of VDF homopolymers.

Therefore, a first object of the present invention is a vinylidene fluoride (VDF) copolymer [polymer (A)] comprising:

a) recurring units derived from vinylidene fluoride (VDF);
b) recurring units derived from at least one perfluoroalkylvinylether (PAVE) monomer, wherein the (PAVE) monomer is selected from the group consisting of:
perfluoroalkylvinylethers complying with formula CF₂═CFOR_{f1}, in which R_{f1} is a C₁-C₆-perfluoroalkyl group; and
perfluorooxyalkylvinylethers complying with formula CF₂═CFOR_{OF}, with R_{OF} being a C₁-C₁₂-perfluorooxyalkyl, which comprises one or more than one ethereal oxygen atom; and preferably R_{OF} being a group of formula —CF₂OR_{f2} or —CF₂CF₂OR_{f2}, with R_{f2} being a C₁-C₆ perfluoroalkyl; and

c) recurring units derived from at least one hydrophilic (meth)acrylic monomer (MA) of formula (I):

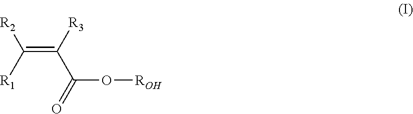

wherein each of R₁, R₂, R₃, equal or different from each other, is independently an hydrogen atom or a C₁-C₃ hydrocarbon group, and R_{OH} is a hydrogen or a C₁-C₅ hydrocarbon moiety comprising at least one hydroxyl group,
wherein the total amount of recurring units b) and c) is at most of 15% by moles, preferably at most 7% by moles, more preferably at most 4% by moles, with respect to the total moles of recurring units of polymer (A).

In a second object, the present invention provides a process for the preparation of polymer (A).

In a third object, the present invention provides a method for the preparation of a film of polymer (A).

In a further object, the present invention provides a film of polymer (A), said film being characterized by improved flex life.

### DESCRIPTION OF EMBODIMENTS

By the term “recurring unit derived from vinylidene difluoride” (also generally indicated as vinylidene fluoride 1,1-difluoroethylene, VDF), it is intended to denote a recurring unit of formula (I):

CF₂═CH₂

Preferred perfluoroalkylvinylethers complying with formula CF₂═CFOR_{f1} include, notably, those wherein Rn is the perfluorinated alkyl group —CF₃ (perfluoromethylvinylether (PMVE)), —C₂F₅ (perfluoroethylvinylether (PEVE)), —C₃F₇ (perfluoropropylvinylether (PPVE)), —C₄F₉ or —C₅F₁₁ group.

Preferred perfluorooxyalkylvinylether group of complying with formula CF₂═CFOR_{OF} include, notably, those wherein R_{OF} is a perfluorooxyalkyl group of formula —CF₂OR_{f2}, with R_{f2} being a C₁-C₃ perfluoroalkyl group, such as —CF₂CF₃ and —CF₃.

The recurring units derived from (PAVE) monomer included in polymer (A) of the invention more preferably are recurring units derived from perfluoromethylvinylether (PMVE).

The term “at least one hydrophilic (meth)acrylic monomer (MA)” is understood to mean that the polymer (A) may comprise recurring units derived from one or more than one hydrophilic (meth)acrylic monomer (MA) as above described. In the rest of the text, the expressions “hydrophilic (meth)acrylic monomer (MA)” and “monomer (MA)” are understood, for the purposes of the present invention, both in the plural and the singular, that is to say that they denote both one or more than one hydrophilic (meth)acrylic monomer (MA).

Non-limitative examples of hydrophilic (meth)acrylic monomers (MA) of formula (II) include, notably:
acrylic acid (AA)
(meth)acrylic acid,
hydroxyethyl(meth)acrylate (HEA),
2-hydroxypropyl acrylate (HPA),
hydroxyethylhexyl(meth)acrylate,
   and mixtures thereof.

The hydrophilic (meth)acrylic monomer (MA) preferably complies with formula (II) here below:

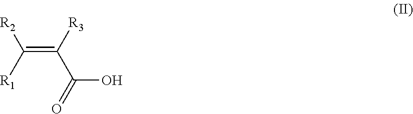

wherein each of R₁, R₂ and R₃, equal to or different from each other, is independently a hydrogen atom or a C₁-C₃ hydrocarbon group.

Still more preferably, the hydrophilic (meth)acrylic monomer (MA) is acrylic acid (AA).

The inventors have found that best results are obtained when the polymer (A) is a linear semi-crystalline co-polymer.

The term “linear” is intended to denote a co-polymer made of substantially linear sequences of recurring units from (VDF) monomer, (meth)acrylic monomer and perfluoroalkylvinylether (PAVE); polymer (A) is thus distinguishable from grafted and/or comb-like polymers.

Good results have been obtained when the total amount of recurring units b) and c) in polymer (A) is at most of 15% by moles, preferably at most 7% by moles, more preferably at most 4% by moles, with respect to the total moles of recurring units of polymer (A).

In a preferred embodiment of the invention, in polymer (A) recurring units deriving from the hydrophilic (meth)acrylic monomer (MA) of formula (I) are comprised in an amount of from 0.05% to 2% by moles, preferably from 0.1 to 1.8% by moles, more preferably from 0.2 to 1.5% by moles with respect to the total moles of recurring units of polymer (A).

Recurring units deriving from (PAVE) monomer are preferably comprised in in polymer (A) in an amount of from 0.05 to 10% by moles, preferably from 0.1 to 7% by moles, more preferably from 0.2 to 3.8% by moles with respect to the total moles of recurring units of polymer (A).

In a more preferred embodiment of the invention, in polymer (A) recurring units deriving from the hydrophilic (meth)acrylic monomer (MA) of formula (I) are comprised in an amount of from 0.2 to 1.5% by moles with respect to the total moles of recurring units of polymer (A), and recurring units deriving from the (PAVE) monomer is comprised in an amount of from 0.2 to 3.8% by moles with respect to the total moles of recurring units of polymer (A).

Determination of average mole percentage of monomer (MA) monomer (PAVE) and VDF recurring units in polymer (A) can be performed by any suitable method, NMR being preferred.

The polymer (A) of the invention may further comprise recurring units derived from one or more fluorinated comonomers (F) different from the perfluoroalkylvinylether as defined above.

By the term “fluorinated comonomer (F)”, it is hereby intended to denote an ethylenically unsaturated comonomer comprising at least one fluorine atoms.

Non-limitative examples of suitable fluorinated comonomers (F) include, notably, the followings:

(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins, such as vinylidene fluoride (VDF), vinyl fluoride; 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE).

Should one or more fluorinated comonomers (F) be present, the polymer (A) of the invention comprises typically from 0.1 to 10% by moles, preferably from 0.3 to 5% by moles, more preferably from 0.5 to 3% by moles of recurring units derived from said fluorinated comonomer (F).

Nevertheless, embodiments wherein the polymer (A) is free from said additional comonomers (F) are preferred.

In a preferred embodiment of the invention, the hydrophilic (meth)acrylic monomer (MA) is a hydrophilic (meth)acrylic monomer of formula (II), still more preferably it is acrylic acid (AA), and the (PAVE) monomer is PMVE, and polymer (A) is a VDF-AA-PMVE terpolymer.

In a preferred embodiment of the invention, the intrinsic viscosity of polymer (A), measured in dimethylformamide at 25° C., is comprised between 0.20 l/g and 0.60 l/g, preferably between 0.25 l/g and 0.50 l/g, more preferably between 0.25 g/l and 0.35 g/l

Preferably, the intrinsic viscosity of polymer (A), measured in dimethylformamide at 25° C., is of about 0.30 l/g.

Excellent results have been obtained using a polymer (A) consisting essentially of:
from 0.2 to 1.5% by moles with respect to the total moles of recurring units of polymer (A) of recurring units derived from monomer (MA),
from 0.2 to 3.8% by moles with respect to the total moles of recurring units of polymer (A) of recurring units derived from (PAVE) monomer; and
from 94.7% to 99.6% by weight, more preferably 96.0% to 98.3% by weight of recurring units derived from VDF.

It is understood that chain ends, defects or other impurity-type moieties might be comprised in the polymer (A) without these impairing its properties.

The polymer (A) is typically obtainable by emulsion polymerization or suspension polymerization of a VDF monomer, at least one hydrogenated (meth)acrylic monomer (MA), at least one monomer (PAVE) and optionally at least one comonomer (F), according to the procedures described, for example, in WO 2007/006645 and in WO 2007/006646.

The polymerization reaction is generally performed at temperatures of between 25 and 150° C., at a pressure of up to 130 bar.

Polymer (A) is typically provided in the form of powder.

The process of the invention provides polymer (A) wherein the monomer (MA) has a substantially random distribution throughout the whole VDF backbone of the polymer (A).

The Applicant has surprisingly found that when combining VDF with recurring units derived from both a hydrophilic (meth)acrylic monomer (MA) and a perfluoroalkylvinylether (PAVE) the productivity of the polymerization is significantly improved, leading to polymer (A) in shorter time.

It is known that longer polymerization time leads to a dirtier reactor at least when polymerizing in suspension, which is an important issue when industrialization takes place.

Data provided in the examples well demonstrate that the introduction of recurring units derived from (MA) monomer and (PAVE) monomer as above specified enables the optimization flexibility properties (flex-life) of VDF-based polymer while improving the productivity of the polymerization in comparison with polymerization wherein recurring units derived from (PAVE) monomer are not present.

Flexible films of polymer (A) can be obtained by processing polymer (A), said films being flexible enough to be used in applications where outstanding flexibility is required, such as in products which undergo dynamic flexing at low temperatures.

In another object of the present invention it is thus provided a film of polymer (A), said film being characterized by improved flex life.

As used herein, a “flexible” product, such as a flexible film, is a solid non-rigid object having a shape that is adjustable with no more than hand force to produce the shape change.

Suitably, the film of polymer (A) has a thickness comprised between 5 and 500 micrometers.

The film of polymer (A) may be prepared by processing polymer (A) by casting a composition comprising polymer (A) onto an inert support or by compression moulding polymer (A) at a temperature of at least 200° C. between two foils of an inert support.

It has been found that the presence of both recurring units derived hydrophilic (meth)acrylic monomers and from perfluoroalkylvinylether monomers in the polymer (A) of the present invention is also associated with the improvement of adhesion to metals of the VDF-based copolymers.

In a preferred embodiment, the film of polymer (A) may be prepared by compression moulding between two foils of polyimide at a temperature of about 250° C.

Should the disclosure of any patents, patent applications, and publications which are incorporated herein by reference conflict with the description of the present application to the extent that it may render a term unclear, the present description shall take precedence.

The invention will be now described in more detail with reference to the following examples, whose purpose is merely illustrative and not limitative of the scope of the invention.

### EXPERIMENTAL PART

### Raw Materials

Polymer (C1): VDF-AA (1.0% by moles) polymer having an intrinsic viscosity of 0.30 l/g in DMF at 25° C.

Polymer (A-1): VDF-AA (1.0% by moles)-PMVE (1.7% by moles) polymer having an intrinsic viscosity of 0.294 l/g in DMF at 25° C.

Polymer (A-2): VDF-AA (0.9% by moles)-PMVE (0.6% by moles) polymer having an intrinsic viscosity of 0.31 l/g in DMF at 25° C.

Initiator agent: t-amyl-perpivalate in isododecane (a 75% by weight solution of t-amyl perpivalate in isododecane), commercially available from Arkema.

Suspending agent (B): Alcotex AQ38, a 38 g/l solution of Alcotex 80 in water: 80% hydrolyzed high molecular weight polyvinyl alcohol, commercially available from SYNTHOMER.

Determination of Intrinsic Viscosity of Polymer (A)

Intrinsic viscosity (q) [dl/g] was measured using the following equation on the basis of dropping time, at 25° C., of a solution obtained by dissolving the polymer (A) in N,N-dimethylformamide at a concentration of about 0.2 g/dl using a Ubbelhode viscosimeter:

$$[ η ] = \frac{{η}_{s p} + Γ \cdot ln {η}_{r}}{( 1 + Γ ) \cdot c}$$

where c is polymer concentration [g/dl], ηᵣ is the relative viscosity, i.e. the ratio between the dropping time of sample solution and the dropping time of solvent, ηₛₚ is the specific viscosity, i.e. ηᵣ−1, and Γ is an experimental factor, which for polymer (F) corresponds to 3.

DSC Analysis

DSC analyses were carried out according to ASTM D 3418 standard; the melting point (T_{f2}) was determined at a heating rate of 10° C./min.

### Example 1: General Procedure for the Preparation of Polymer (A) and (C1)

In a 4 litres reactor equipped with an impeller running at a speed of 650 rpm were introduced in sequence of demineralised water and 1.5 g/kg Mni (initial of monomers added in reactor before the set point temperature) of suspending agent. The reactor was purged with sequence of vacuum (30 mmHg) and purged of nitrogen at 11° C. Then 5.0 g of initiator agent were introduced. At a speed of 880 rpm, the acrylic acid (AA) and the perfluoromethyl vinyl ether (PMVE) were introduced. Finally, the vinylidene fluoride (VDF) was introduced in the reactor. The amounts of AA, PMVE and VDF in the polymers (A) used in the preparation of the polymer (A) according to the invention (and in the comparative polymer (C1)) are reported in Table 1. The reactor was gradually heated until a set-point temperature at 55° C. and the pressure was fixed at 120 bar. The pressure was kept constantly equal to 120 bar by feeding during the polymerization, the acrylic acid in aqueous solution with a concentration of AA as described in the table B. After this feeding, no more aqueous solution was introduced and the pressure started to decrease. The polymerization was stopped by degassing the reactor until reaching atmospheric pressure. A conversion of monomers was reached as described in Table A. The polymer so obtained was then recovered, washed with demineralised water and dried at 65° C. during all the night.

TABLE 1

| | | | | | AA feeding |
|---|---|---|---|---|---|
| | | | | AA | g |
| | Water | VDF | PMVE | Initial | ([AA] in water |
| Polymers | g | g | g | g | g/kg water) |
| (C1) | 1997 | 1280 | 0 | 0.55 | 13.55 (14.9) |
| (A-1) | 2055 | 1216 | 66 | 0.55 | 13.55 (15.8) |
| (A-2) | 2030 | 1256 | 25 | 0.55 | 13.55 (15.3) |

In Table 2 the time and yield of polymerizations and the properties of the obtained polymers are reported.

TABLE 2

| | Time of | | η in DMF | | NMR composition | | |
|---|---|---|---|---|---|---|---|
| | polymerization | Yield | at 25° | Tf2 | (mol %) | | |
| | Minutes * | % | C. l/g | ° C. | VDF | PMVE | AA |
| (C1) | 392 | 78 | 0.30 | 162.7 | 99.0 | — | 1.0 |
| (A-1) | 360 | 76 | 0.294 | 150 | 97.3 | 1.7 | 1.0 |
| (A-2) | 343 | 77 | 0.31 | 157.5 | 98.5 | 0.6 | 0.9 |

* Time between the startup (Temperature of polymerization (55° C.) and the start of the reactor degassing

### Example 2: General Procedure for the Preparation of Films

The polymer was compression moulded between two aluminium foils at a temperature of 240° C. to produce a film of about 300 microns thickness.

### Example 3: M.I.T. Flex Life Measurement of Polymer (A)

The films of polymers prepared as described in Example 1 were tested in a M.I.T machine (Folding Indurance Tester from Tinius Olsen, testing machine Co, Willow Growe, (PA)) at 23° C. at a speed of 90 cycles/min with a weight of 2 lbs. The test was considered over when the sample broke.

The value of MIT Flex life is an average of the values obtained by testing at least three films for each polymer.

In Table 3 the data of flex life for the three polymers C1, A-1 and A-2 are reported.

TABLE 3

| | Flex life |
|---|---|
| Film of polymer | No cycles up to break |
| (C1) | 5349 |
| (A-1) | 21319 |
| (A-2) | 9419 |

As shown in Table 3, the polymer (A) of the present invention as notably embodied by any of the polymers (A-1) and (A-2), advantageously exhibits higher flex life in comparison with the comparative polymer (C1).

In view of the above, it has been found that the polymer (A) of the present invention or any films thereof is particularly suitable for use in applications where outstanding flexibility is required.

1-14. (canceled)

15. A vinylidene fluoride (VDF) polymer (A) comprising:
recurring units derived from vinylidene fluoride (VDF);
recurring units derived from at least one perfluoroalkylvinylether (PAVE) monomer, wherein the (PAVE) monomer is selected from the group consisting of:
perfluoroalkylvinylethers complying with formula CF₂═CFOR_{f1} in which R_{f1} is a C₁-C₆-perfluoroalkyl group; and
perfluorooxyalkylvinylethers complying with formula CF₂═CFOR_{OF}, with R_{OF} being a C₁-C₁₂-perfluorooxyalkyl, which comprises one or more than one ethereal oxygen atom; and
recurring units derived from at least one hydrophilic (meth)acrylic monomer (MA) of formula (I):
a. 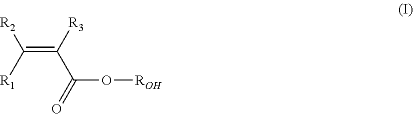
wherein each of R₁, R₂, R₃, equal or different from each other, is independently an hydrogen atom or a C₁-C₃ hydrocarbon group, and R_{OH} is a hydrogen or a C₁-C₅ hydrocarbon moiety comprising at least one hydroxyl group,
wherein the total amount of recurring units b) and c) is at most of 15% by moles, with respect to the total moles of recurring units of polymer (A).

16. The polymer (A) of claim 15 wherein the at least one hydrophilic (meth)acrylic monomers (MA) of formula (I) is selected from the group comprising acrylic acid (AA), (meth)acrylic acid, hydroxyethyl(meth)acrylate (HEA), 2-hydroxypropyl acrylate (HPA), hydroxyethylhexyl(meth)acrylate, and mixtures thereof.

17. The polymer (A) of claim 15, wherein the perfluoroalkylvinylether (PAVE) is selected from the group comprising perfluoromethylvinylether (PMVE), perfluoroethylvinylether (PEVE) and perfluoropropylvinylether (PPVE).

18. The polymer (A) of claim 15, wherein the polymer (A) is a terpolymer VDF-AA-PMVE.

19. The polymer (A) of claim 15, wherein the polymer (A) comprises an intrinsic viscosity, measured in dimethylformamide at 25° C., of about 0.30 l/g.

20. The polymer (A) of claim 15, wherein the polymer (A) comprises from 0.05% to 2% by moles of the recurring units derived from hydrophilic (meth)acrylic monomer (MA), with respect to the total moles of recurring units of polymer (A).

21. The polymer (A) of claim 15, wherein the polymer (A) comprises from 0.2 to 10% by moles recurring units derived from (PAVE), with respect to the total moles of recurring units of polymer (A).

22. The polymer (A) according to claim 15, wherein the polymer (A) comprises
0.2 to 1.5% by moles of the recurring units derived from the hydrophilic (meth)acrylic monomer (MA), with respect to the total moles of recurring units of polymer (A), and
0.2 to 3.8% by moles of the recurring units derived from the (PAVE) monomer, with respect to the total moles of recurring units of polymer (A).

23. The polymer (A) according to claim 15 consisting essentially of:
from 0.2 to 1.5% by moles with respect to the total moles of recurring units of polymer (A) of recurring units derived from monomer (MA),
from 0.2 to 3.8% by moles with respect to the total moles of recurring units of polymer (A) of recurring units derived from (PAVE) monomer; and
from 94.7% to 99.6% by weight, more preferably 96.0% to 98.3% by weight of recurring units derived from VDF.

24. A film comprising the polymer (A) of claim 15.

25. The film of claim 24, comprising a thickness of from 5 to 500 micrometers.

26. A process for the preparation of the film of claim 24, process comprising processing polymer (A).

27. The process of claim 26, the process comprising casting a composition comprising the polymer (A).

28. The process of claim 26, the process comprising compression molding the polymer (A) at a temperature of at least 200° C. between two foils of an inert support.
